(19) United States
(12) Patent Application Publication
(10) Pub. No.: US 2020/0232878 A1
(43) Pub. Date: Jul. 23, 2020

(54) TESTING OF INTEGRATED OPTICAL MIXERS

(71) Applicant: Elenion Technologies, LLC, New York, NY (US)

(72) Inventors: Yangjin Ma, Brooklyn, NY (US); Ruizhi Shi, White Plains, NY (US); Noam Ophir, New York, NY (US); Ran Ding, New York, NY (US)

(21) Appl. No.: 16/250,002

(22) Filed: Jan. 17, 2019

(51) Int. Cl. G01M 11/00; G02B 6/26

(52) U.S. Cl. CPC G01M 11/335; G01M 11/333; G02B 6/26

(57) ABSTRACT

A method and structure are provided for testing photonic circuits with integrated optical mixers having idle ports. A test port is provided for coupling test light into one or more idle ports of the mixer. Light exiting output ports of the mixer may be measured with photodetectors. Phase errors of optical hybrids may be determined by using waveguides of different lengths to inject test light into two input ports of the mixer and scanning the test wavelength. The method and structure may be used for on-wafer and off-wafer measurements of integrated photonic circuits implementing coherent optical receivers.

### FIELD OF THE INVENTION

The invention generally relates to photonic integrated circuits, and more particularly relates to methods, devices, and structures for on-wafer and individual testing of photonic integrated circuits that include optical mixers.

### BACKGROUND OF THE INVENTION

Photonic integrated circuits (PIC) are used to implement various optical devices for optical communication systems and other applications. A significant expense in the production of PICs is testing during manufacture. Typically multiple instances of a PIC are fabricated on a single wafer, and are then diced into separate photonic chips that may be tested individually. Testing discrete chips is a costly process. When manipulating the chips individually there is a possibility of damaging the chip. Some packaging may also be needed, such as wire bonding or fiber attachment, before testing can occur. It may be therefore preferred to test each PIC on wafer before dicing the wafer into individual chips. However, it may be difficult to optically access a PIC before it is separated from the wafer, or when the PIC is installed in a target system, in a way that enables adequately characterizing the PIC.

There is a need for improved approaches to testing of PICs and elements thereof.

### SUMMARY OF THE INVENTION

An aspect of the present disclosure relates to a method for on-wafer or off-wafer testing of a photonic integrated circuit (PIC) comprising an optical mixer defined at least in part in an optical layer of a wafer, the optical mixer comprising a plurality of input ports and a plurality of output ports, the plurality of input ports comprising one or more operative input ports and one or more idle ports, the method comprising: providing a first test port in the wafer, the first test port configured to receive test light incident thereon at an angle to the optical layer and to redirect the test light to propagate in the optical layer; and, optically connecting the first test port to the one or more idle ports of the optical mixer with one or more optical waveguides defined in the PIC.

An aspect of the present disclosure relates to a method for on-wafer testing of a photonic integrated circuit (PIC) comprising an optical mixer defined at least in part in an optical layer of a wafer, the optical mixer comprising a plurality of input ports and a plurality of output ports, the plurality of input ports comprising two or more operative input ports and one or more idle input ports, the method comprising: coupling test light into at least one of the one or more idle ports of the optical mixer; and, measuring light exiting the optical mixer from at least two of the output ports.

According to a feature of the present disclosure, the method may comprise: splitting the test light into two light portions, directing the two light portions to couple into two input ports of the optical mixer along optical paths of different lengths, varying a wavelength of the test light across a test wavelength range, and recoding a relative power of the light exiting each output port from the plurality of output ports of the optical mixer in dependence on the wavelength to obtain an output spectrum for each of the plurality of output ports.

An aspect of the present disclosure relates to a photonic integrated circuit (PIC) comprising: one or more optical layers supported by a substrate; one or more input optical ports for receiving light signals during normal operation of the PIC; and a first optical mixer formed at least in part in the one or more optical layers an optically coupled to the one or more input optical ports. The first optical mixer may comprise a plurality of output ports and a plurality of input ports. The plurality of input ports may comprise one or more operative input ports optically coupled to the one or more input optical ports, and at least one idle port. The PIC may further comprise a first test port supported by the substrate and configured to couple test light into at least one of the one or more idle ports for optical testing of the first optical mixer.

### BRIEF DESCRIPTION OF THE DRAWINGS

Embodiments disclosed herein will be described in greater detail with reference to the accompanying drawings, which may be not to scale and in which like elements are indicated with like reference numerals, and wherein:

FIG. 1A is a schematic plan view of a wafer incorporating a plurality of integrated photonic circuits (PICs);

FIG. 1B is a schematic side view of the wafer of FIG. 1;

FIG. 2 is a schematic plan view of a PIC incorporating a 4×4 optical mixer and a test port connected to idle ports of the optical mixer;

FIG. 3 is a schematic side view of the PIC of FIG. 2 illustrating the coupling of test light;

FIG. 4 is a flowchart of a method for testing a PIC including an optical mixer for phase errors;

FIG. 5 is a graph showing photocurrents of four PDs coupled to the output ports of a 90° optical hybrid vs. the wavelength of test light injected into the idle ports of the optical hybrid along optical paths of different lengths;

FIG. 6 is a schematic diagram illustrating a plan view of an embodiment of the PIC of FIG. 2 with two additional test ports separate coupled to the two idle ports of the optical mixer for port to port coupling measurements;

FIG. 7 is a schematic plan view of a PIC incorporating a 3×3 optical mixer and a test port optically coupled to an idle port and an operating port of the optical mixer;

FIG. 8 is a schematic plan view of a PIC with two optical mixers for polarization diversity coherent optical reception, and a test port optically coupled to an idle port and an operating port of each optical mixer along optical paths of different lengths;

FIG. 9 is a schematic plan view of a PIC with two optical mixers having four input ports for polarization diversity coherent optical reception, each optical mixer provided with a separate test port;

FIG. 10 is a schematic plan view of a PIC including an N×M optical mixer operating as 1×M splitter, and a test port optically coupled to an idle port of the N×M optical mixer for testing power splitting ratios.

### DETAILED DESCRIPTION

In the following description, for purposes of explanation and not limitation, specific details are set forth, such as particular optical circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Furthermore, the following abbreviations and acronyms may be used in the present document:

GaAs Gallium Arsenide

InP Indium Phosphide

PIC Photonic Integrated Circuit

SOI Silicon on Insulator

MUX Multiplexer

DP Dual Polarization

QPSK Quadrature Phase Shift Keying

QAM Quadrature Amplitude Modulation

MMI Multi Mode Interference

In the following description, the term “light” refers to electromagnetic radiation with frequencies in the visible and non-visible portions of the electromagnetic spectrum. The term “optical” relates to electromagnetic radiation in the visible and non-visible portions of the electromagnetic spectrum. The terms “first”, “second” and so forth are not intended to imply sequential ordering, but rather are intended to distinguish one element from another, unless explicitly stated. Similarly, sequential ordering of method steps does not imply a sequential order of their execution, unless explicitly stated. As used herein the term “substrate” encompasses a silicon wafer, a silicon on insulator (SOI) wafer, a semiconductor wafer comprising material such as III-V compounds such as GaAs, InP and alloys of such III-V compounds, and wafers made of materials that are not semiconducting such as quartz and alumina. The term “optical mixer”, as used herein, encompasses optical couplers and optical hybrids.

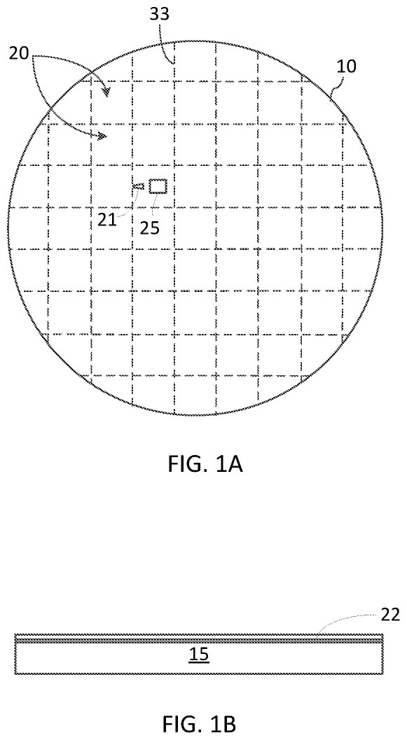

Referring to FIGS. 1A and 1B, there is schematically illustrated a wafer 10 having at least one optical layer 22 where light can propagate, the at least one optical layer supported by a substrate 15. A plurality of photonic chips 20 is defined in or upon the wafer. Each of the photonic chips 20 may include at least one input optical port 21, which in some embodiments may be in the form of an edge coupler disposed with a coupling end adjacent to an edge of the photonic chip and configured for connecting to an outside optical circuit when the corresponding chip 20 is separated from wafer 10. Each of the chips 20 may also include one or more optical waveguides and/or optical devices 25, which may form a photonic integrated circuit (PIC) with the input optical port or ports 21.

Photonic chips 20 may include one or more optical mixers capable of mixing two light signals in particular phase relationships and proportions. Examples of such optical mixers include 2×2 directional couplers and optical hybrids (OHs), such as for example 120° OHs and 90° OHs, among others. It is often desirable to know the phase and power relationships between the mixed light signals at the output(s) of the optical mixers, and/or how they deviate from a desired target. Optical hybrids are used in integrated coherent optical receivers with phase diversity. In such receivers the OHs are to mix signal light and local oscillator (LO) light at a set of phase shift ϕᵢ therebetween, with a target phase shift increment Δϕ₀ from output port to output port of 90° typically, or 120° in some embodiments. A deviation δϕ=(Δϕ−Δϕ₀) of an actual inter-port phase shift increment Δϕ from a target phase shift increment value Δϕ₀ in an optical hybrid is referred to as a phase error of the optical hybrid, or generally of an optical mixer. The phase error of an OH used in an integrated coherent receiver can affect its performance, and therefore may be an important quality parameter of a coherent receiver. In a typical integrated coherent receiver architecture, such as a DP-QPSK receiver among others, the PIC implementing an optical front-end of the receiver may be edge-coupled, since an edge coupler can be relatively easily configured to support both polarizations and be largely wavelength insensitive. However, characterizing an edge-coupled PIC when the PIC is a part of a communication system may be complicated and time consuming. An ability to measure the phase error and/or other characteristics such as power splitting ratio(s) of an optical mixer on-wafer, prior to separating the optical chips from the wafer, is desirable. Characterizing the phase error of a coherent receiver on a wafer scale could save testing time by orders of magnitude compared to chip scale testing via edge coupling.

An aspect of the present disclosure relates to a technique, and related optical circuits and devices, wherein testing of integrated optical mixers is performed using test ports connected to idle input ports of the optical mixers. The approach may be used for example for testing PICs implementing coherent optical receivers, among others. In some embodiments the test port or ports may be implemented as vertical couplers, which may enable on-wafer testing. The term “idle port” refers to a port of an optical mixer, which may be at an input side thereof, that is not used during normal operation of the PIC and is not edge-coupled, but which is optically coupled to at least some of the output ports of the optical mixer. The presence of such ports is a feature of many types of optical mixers, including 2×2 directional couplers that are used as optical splitters or optical combiners, and various types of optical hybrids. For example a 90° optical hybrid used in a coherent receiver may be implemented with a 4×4 MMI coupler having four input ports and four output ports, with only two input ports used to receive LO and signal light, which leaves two idle ports at the input side. As the 4×4 MMI is symmetric, the phase error and output power balance at the output ports thereof may be measured by inputting light from either the top two ports or the bottom two ports.

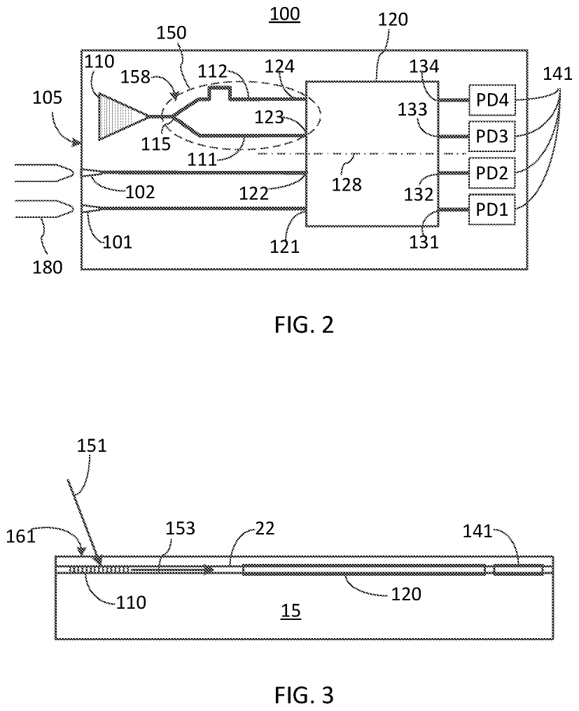

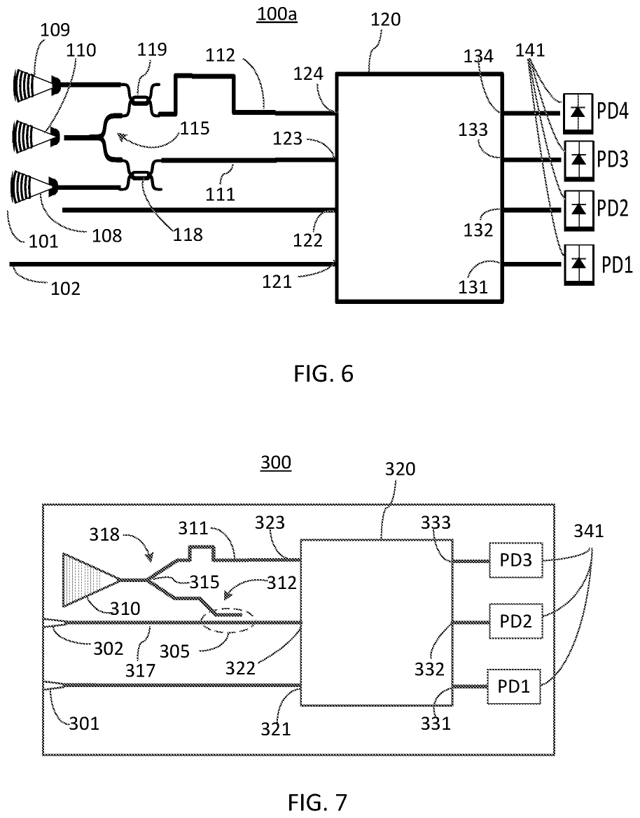

FIG. 2 illustrates, in a plan view, an example PIC 100 that may be implemented in one of the photonic chips 20 according to an embodiment. FIG. 3 illustrates a side view of the PIC, which may be formed in an optical layer or layers 22 of the chip that is supported by the substrate 15. The substrate 15 may include one or more layers of different materials. In an example embodiment, the optical layer 22 may be a silicon (Si) layer of a SOI chip or wafer. It will be appreciated that FIGS. 2 and 3, as well as FIGS. 6-10 described below, may schematically represent a portion of a larger PIC that may be implemented in a same chip 20, and which may have other optical elements that may be optically connected to one or more of the elements illustrated in respective figures.

As illustrated in FIG. 2, PIC 100 includes two input optical ports 101 and 102, which may be referred to as the PIC input ports. The PIC input ports 101, 102 may be each in the form of an edge coupler that terminate at an edge 105 of an optical chip containing PIC 100. The PIC input ports 101, 102 may be configured for edge-coupling of light, for example from optical fibers 180 or from a butt-coupled optical source, into PIC 100 during normal operation thereof when the PIC is separated from a wafer and installed in an optical system, for example an optical communication system. PIC 100 may further include an optical mixer (OM) 120 having first and second operative input ports 121 and 122 optically coupled to the first and second PIC optical ports 101 and 102, and four output ports 131-134. The optical mixer 120 may be formed at least in part in the optical layer or layers 22, or in another optical layer of the chip. The four output ports 131-134 of the optical mixer 120 may be individually optically coupled to four photodetectors (PDs) 141 on the one-to-one basis to separately detect optical signals emitted from the four output ports 131-134. PIC 100 may implement an optical front-end of a coherent receiver, or a single-polarization portion thereof, with the optical mixer 120 configured as a 90° optical hybrid. In operation, one of the first and second optical ports 101, 102 of the PIC may receive signal light Si, the other—LO light S₂. The signal and LO light are then coupled into the OM 120 via the first and second operative input ports 121 and 123 using optical waveguides. The output ports 131-134 emit mixed light signals in which the signal light and the LO light is coherently mixed with the optical phase shift therebetween φᵢ, i=1, . . . , m, that increments nominally by Δϕ₀=90° from one output port of the OM 120 to another; here “m” denotes the number of output ports of the OM.

The OM 120 may be in the form of a 4×4 MMI coupler and may also include two additional input ports 123 and 124, which are not connected to edge couplers and may remain unused during normal operation of the PIC 100. These two additional input ports 123, 124 of the OM 120 may be referred to as the first and second idle input ports 123, 124, or as the first idle port 123 and a second idle port 124, respectively. Due to a symmetry of a 4×4 MMI coupler with respect to a longitudinal axis 128 thereof, these idle input ports 123 and 124 may be used to test performance characteristics of the OM 120, such as the phase error and/or port-to-port coupling uniformity. A test port 110 may be provided in the PIC 100 to couple test light into the first idle port 123 and/or the second idle port 124 of the OM 120. Note that the solid lines connecting various elements of PIC 100 in FIG. 2 represent optical connections, which may be for example in the form of optical waveguides integrated into the PIC.

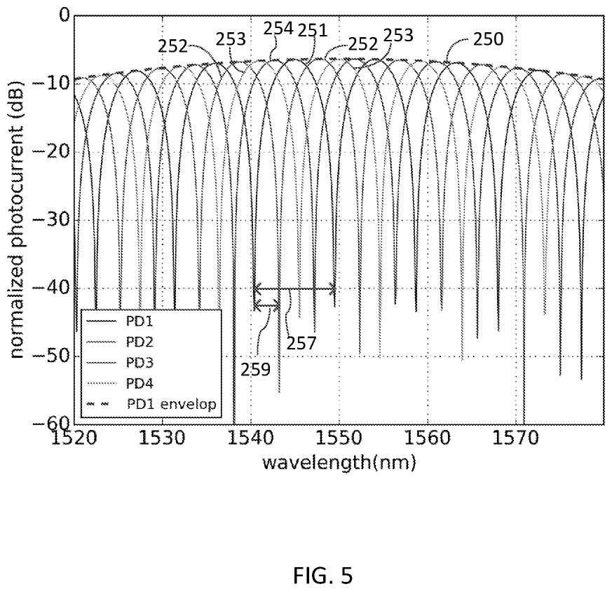

In some embodiments the test port 110 may be configured to couple test light 151 (FIG. 3), which may be directed upon a free surface 161 of the chip or the wafer from outside at an angle to a free surface 161 of the chip or the wafer, into an optical layer of the chip and ultimately into the idle port(s) of the OM 120; the test light may then be measured by the PDs 141 after propagation through the OM 120 to characterize the optical mixer. The test port 110 may be in the form of a vertical coupler configured to change the propagation angle of the test light 151 so it may be injected into the idle input ports 123, 124 of the OM 120 from a source outside of the chip or the wafer. In some embodiments the test port 110 may be implemented with a diffraction grating configured to couple light into an optical layer of the chip from outside of the chip and wafer. In some embodiments it may be implemented using slanted reflective surfaces formed through the optical layer or layers 22. The test port 110 may be also referred to herein as the first test port or the first vertical coupler when describing some of the embodiments. In the context of this specification “vertical” in the terms “vertical coupler” or “vertical grating” does not imply a particular angle of incidence of the test light upon a surface of a chip or wafer where the coupler is implemented, except that the test light is being coupled from outside the chip or wafer. The test port 110 may be optically connected to the idle OM ports 123, 124 with an optical waveguide interconnect 158 formed of an optical splitter 115 and two waveguide legs forming a first optical path 111 and a second optical path 112 for the test light 151. The first optical path 111 optically connects the first idle OM port 123 to the test port 110 via the optical splitter 115. The second optical path 112 optically connects the second idle OM port 124 to the test port 110 via the optical splitter 115. In some embodiments the first optical path 111 may differ in length from the second optical path 112 by a distance d, so as to form an unbalanced Mach-Zehnder interferometer (MZI) 150 bounded by the optical splitter 115 and the OM 120. The distance d may be selected to provide a desired free spectral range (FSR) of the unbalanced MZI 150, which may be smaller than a test wavelength range but at least 10 times greater than a wavelength resolution of a testing setup. In some embodiments d may be at least 20 micrometers (μm); in some embodiments it may be in the range of 20 to 1000 μm, by way of example. The range of in which the distance d may vary depends on a particular implementation of the PIC and the testing setup. It may be determined for example by the spectral resolution of a source of the test light 151, such as a wavelength-sweeping laser, and an index contrast of the optical waveguides in the PIC. For example, to get a free spectral range (FSR) Λ (257 in FIG. 5) of the unbalance MZI of about 1 nm at a wavelength near 1550 nm in a SOI platform with optical group index of ˜4, d may be about 600 μm.

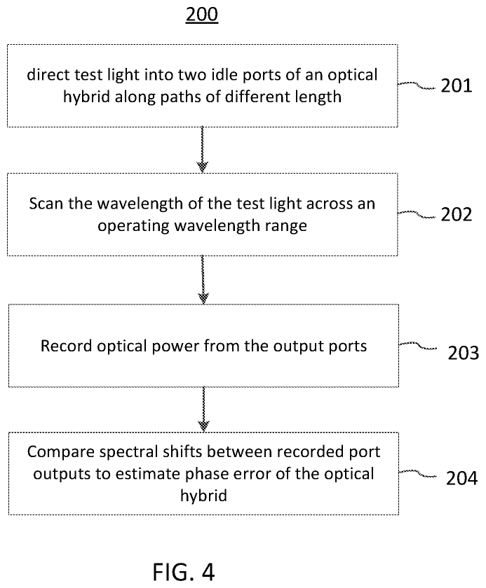

With reference to FIG. 4, in one embodiment the process of testing PIC 100 may include: (201) directing test light 151 to impinge upon the test port 110 so as to be coupled into the PIC 100, and (203) recording PD signals Jᵢ, i=1, . . . , m from the PDs 141. Here m is the number of output ports of the OM 120, and is equal to 4 in the embodiment of FIG. 2. The PD signals Jᵢ are indicative of the optical power at each output port, and may be used to assess one or more characteristics of the OM 120 at (204). In some embodiments the test light 151 may be nearly monochromatic light of a wavelength λ with a coherence length that exceeds the distance d. In some embodiments method 200 may include (202) varying the wavelength λ of the test light 151 across an operating range of the PIC, or at least a portion thereof that exceeds the FSR of the unbalanced MZI 150, while recording the PD signals Jᵢ, i=1, m at (203). Due to a non-zero chromatic dispersion of the waveguide legs forming the optical paths 111, 112 that connect the test port 110 to the OM 120, and their length difference d, the test light 151 enters the first and second idle OM ports 123, 124 with a relative phase shift

$$Δ φ = \frac{2 π}{λ} {n}_{e f f} ( λ ) d$$

that vanes with the test wavelength λ; here n_{eff}(λ) is the wavelength-dependent effective index of the waveguides forming the optical paths 111, 112. At the output OM ports 131-134 the relative phase shift Δϕ adds a component to the phase shifts ϕᵢ that changes approximately linear with the wavelength, resulting in periodic oscillations of the recorded PD signals Jᵢ as function of the test wavelength λ; here ϕᵢ is the phase shift at the i-th output ports between the components of the test light that entered the OM 120 through the two idle ports 123 and 124.

FIG. 5 illustrates the recorded PD signals Jᵢ, i=1, 2, 3, and 4, from the four PDs 141 computed for an example embodiment of PIC 100 configured for operating in the 1550 nm wavelength range, when the test wavelength varies from 1520 nm to 1580 nm. In this example d=75 μm, and each recorded port output signal Jᵢ oscillates with a period Λ 257 of about 8 nm, dropping by at least 30 dB between peak values. Here the PD signal J₁ recorded from the first output port 131 is indicted at 251, the PD signal J₂ recorded from the second output port 132 is indicted at 252, the PD signal J₃ recorded from the third output port 133 is indicted at 253, and the PD signal J₄ recorded from the fourth output port 134 is indicted at 254. For an ideal 90° OH, the curves are shifted relative to each other by exactly a quarter of the period, i.e. by ΔΛ=Λ/4. Accordingly, by comparing the shifts AA 259 between adjacent curves of the recorded PD signals Jᵢ, to each other and/or to the oscillation period Λ 257 of each PD signal, the phase error δ of the OM 120 may be estimated. The power imbalances between output ports 131-134 and can be calculated from an envelope 250 of the recorded spectrum J₁(λ), i=1, . . . , m. For example m spectral envelops of each of the recorded spectra Jᵢ(λ), i=1, . . . , m, from each output port of the OM may be separately estimated and compared to each other to estimate a degree of the power imbalance between the output ports.

FIG. 6 illustrates an embodiment of PIC 100, generally referred to as PIC 100a, with two additional test ports 108 and 109 added to independently probe each of the idle OM ports 124 and 123. The two additional test ports 108 and 109 may be in the form of vertical couplers as described above with reference to the first test port 110. The first additional test port 108 may be optically coupled to the first idle OM port 123 using a first directional coupler 118. The second additional test port 109 may be optically coupled to the second idle OM port 124 using a second directional coupler 119. The first directional coupler 118 may be for example an evanescent optical coupler configured to couple test light received in the first additional test port 108 into the first idle port 123 along the first optical path 111. The second directional coupler 119 may be for example an evanescent optical coupler configured to couple test light received in the second additional test port 109 into the second idle port 124 along the second optical path 112. The process of testing PIC 100a may include directing the test light into the first additional test port 108 and recording the PD signals from the PDs 141. The recorded PD signals may be used to determine a receiver responsivity per output PD 141 for light injected in the first idle port 123, and to estimate relative coupling coefficients between the first idle input port 123 and each of the output OM ports 131-134. The process of testing may also include directing the test light into the second additional test port 109 and recording the PD signals from the PDs 141. The recorded PD signals may be used to determine a receiver responsivity per output PD 141 for light injected in the second idle port 123, and to estimate relative coupling coefficients between the second idle input port 124 and each of the output OM ports 131-134. Due to the symmetry of the OM 120, the coupling coefficients between the input idle ports 123, 124 and the output ports of the OM determined that way may be indicative of the coupling coefficients between the operative input ports 121, 122 and the output OM ports 131-134, in an opposite order. In some embodiments wavelength dependence of the coupling coefficients may be determined by scanning the test wavelength λ during the measurements.

Referring to FIG. 7, in some embodiments, for example where an OM has an odd number of idle ports, a test port may be coupled to one of the operative input ports of the OM. FIG. 7 illustrates an example PIC 300 including an OM 320 having two operative input ports 321, 322 that are coupled to two input optical ports 301, 302 of the PIC, respectively, and one idle input port 323. In the illustrated embodiment the OM 320 has three output ports 331, 332, and 333, but in other embodiments it may have a different number of output ports, for example four. The OM 320 may be, for example, a 3×3 OM configured as a 120° optical hybrid. It may be implemented, for example, with a 3×3 MMI device, or with an optical coupler network. By way of example, a compact 90° optical hybrid with three input ports and four output ports formed of a network of optical couplers is disclosed in U.S. Pat. No. 10,126,498 to Ma et al, which is assigned to the assignee of the present application, and is incorporated herein by reference. The output ports 331-333 of the OM 320 may be individually optically coupled to PDs 341, one PD 341 per port. A test port 310 is provided in PIC 300 for testing the OM 320. The test port 310 may be an embodiment of the test port 110 described above; it may be a vertical coupler, such as for example a grating coupler, configured for injecting test light into the PIC from a free surface of the PIC, generally as illustrated in FIG. 3. An optical waveguide interconnect 318 is provided to optically connect the test port 310 to the idle port 323 of the OM 320 along a first optical path 311 and to one of the first and second operative input ports 321, 322 along a second optical path 312. The optical waveguide interconnect 318 includes an optical splitter 315 that optically connects the test port 310 to the idle port 323 by means of a first waveguide leg implementing the first optical path 311, and to the second operative port 322 by means of a second waveguide leg implementing the second optical path 312, which includes an optical coupler 305. The optical coupler 305 connects the optical splitter 115 to an optical waveguide 317 connecting the second input optical port 302 of the PIC to the second operative input port 322 of the OM 320. In some embodiments the first optical path 311 may differ in length from the second optical path 312 by a distance d, as described above. The distance d may be at least 20 μm, and may be in the range of 20 to 1000 μm, by way of example. By directing test light onto the test port 310, scanning the wavelength of the test light during measurements, and recording signals from the output ports of the OM 320 during the scanning, for example using the PDs 341, the phase error of the OM 320 may be estimated as generally described above with reference to FIGS. 4 and 5.

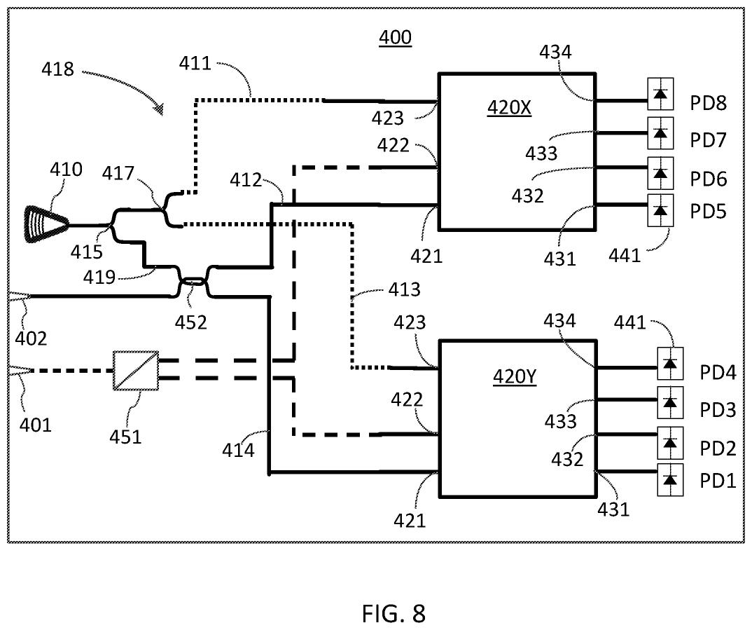

Referring to FIG. 8, in some embodiments a test port may be used for testing of two or more OMs through their respective idle ports. FIG. 8 illustrates an example PIC 400 implementing a dual-polarization (DP) coherent optical receiver according to an example embodiment. It includes two OMs, a first OM 420X and a second OM 420Y, which are used for separately processing two components of signal light that enter the PIC in orthogonal polarizations, which may be referred to as “X” and “Y” polarization channels. The first OM 420X and the second OM 420Y may be referred to herein generally as OM 420, and separately as the X-channel OM 420X and the Y-channel OM 420Y. Each OM 420 may be embodied as a 90° optical hybrid (OH). In the illustrated embodiment each OM 420 has two operative input ports 421 and 422, four output ports 431-434, and one idle port 423. Each output port 431-434 of each OM 420X, 420Y is individually coupled to a corresponding PD 441. The two operative input ports 421 and 422 of each OM 420 may be referred to as the first and second operative input ports, respectively. Two input optical ports 401 and 402 of the PIC are optically coupled to the two operative input ports 422 and 421, respectively, of each OM 420. The input optical ports 401 and 402 may also be referred to as the first PIC port 401 and the second PIC port 402, respectively. In operation one of the input optical ports 401 and 402 may receive the signal light, and the other—LO light. In the example embodiment illustrated in FIG. 8, PIC 400 is configured to receive the signal light into the first PIC port 401, and the LO light into the second PIC port 402. A 2×2 optical coupler 452 is configured to split the LO light received in the second PIC port 402 into first LO light and second LO light; the first LO light is guided to the first operative input port 421 of the X-channel OM 420X, and the second LO light is guided to the first operative input port 421 of the Y-channel OM 420Y. A polarization beam splitter (PBS) 451 is configured to split the signal light received in the first PIC port 401 into signal light of X-polarization and signal light of Y-polarization; the signal light of the X-polarization is guided to the second operative input port 422 of the X-channel OM 420X, and the signal light of the Y-polarization is guided to the second operative input port 422 of the Y-channel OM 420Y. In other embodiments PIC 400 may be configured so that the signal light is directed to the first operative ports 421 of the OMs 420, while the LO light is directed to the second operative ports 422 of the OMs 420. The PBS 451 may include a polarization rotator at one of its output ports so that the signal light of both the X-polarization and the Y-polarization propagate in respective optical waveguides connecting the PBS 451 to the second operative ports 422 of the OMs 420 in a same polarization mode, for example a TE mode of the waveguides.

PIC 400 further includes a test port 410 and an optical waveguide interconnect 418 configured to optically connect the test port 410 to the idle port 423 of each of the X-channel OM 420X and the Y-channel OM 420Y, and to one of the operative input ports of each of the X-channel OM 420X and the Y-channel OM 420Y thereof. The test port 410 may be in the form of a vertical coupler as described hereinabove with reference to embodiments illustrated in FIGS. 2-7. The optical waveguide interconnect 418 includes a first optical splitter 415, a second optical splitter 417, and optical waveguides that connect the test port 410 to the first optical splitter 415, the first optical splitter 415 to the second optical splitter 417, and further to the idle port 423 of each of the X-channel OM 420X and the Y-channel OM 420Y. Each of the first optical splitter 415 and the second optical splitter 417 may be embodied as a 1×2 optical splitter. The optical waveguide interconnect 418 may further include a waveguide 419 that connects the first optical splitter 415 to the 2×2 optical coupler 452, which in turn connects to the first operative ports 421 of each OM 420. The first optical splitter 415 is configured to split test light received from the test port 410 into two portions, one of which is then again split in two by the second optical splitter 417 and directed to the idle ports 423 of the two OM 420X and 420Y along optical paths 411 and 413. The other is guided to the 2×2 optical coupler 452, which outputs are optically coupled to the first operative input ports 421 of the two OM 420X and 420Y along optical paths 412 and 414. In another embodiment portions of the test light may be coupled into the second operative input ports 422 thereof. The optical paths 411, 412, 413, and 414 may be implemented with optical waveguides that are integrated into the PIC and connect the test port 410 to the respective input ports 421, 423 of the X-channel OM 420X and the Y-channel OM 420Y. These optical waveguides are schematically illustrated with solid, dashed, and dotted lines, with the dotted lines indicating parts of the optical paths of the test light to the idle ports 423. The dashed lines may indicate the optical paths of the signal light when the signal light is coupled into the first PIC port 401.

In some embodiments the optical waveguide interconnect 418 may be configured so that the optical paths 411 and 412 from the test port 410 to the idle port 423 and the operative input port of the X-channel OM 420X, respectively, may differ in length by a distance d₁ that is at least 20 um, and may be in the range of 20 to 1000 um, by way of example. The optical paths 413 and 414 from the test port 410 to the idle port 423 and to the operative input port of the Y-channel OM 420Y, respectively, may differ in length by a distance d₂, which may be in the same range as d₁.

The optical paths 411 and 412, which may be referred to as the first and second optical paths 411 and 412, respectively, may be viewed as two legs of a first unbalanced MZI that is bounded by the first optical splitter 415 and the X-channel OM 420X. Similarly the optical paths 413 and 414, which may be referred to as the third optical path 413 and the fourth optical path 414, respectively, may be viewed as two legs of a second unbalanced MZI that is bounded by the first optical splitter 415 and the Y-channel OM 420Y.

PIC 400 may be tested generally as described hereinabove with reference to the embodiments of FIGS. 2 and 6, the flowchart of FIG. 4, and the graph in FIG. 5. The test procedure may include directing test light onto the test port 410, scanning the wavelength of the test light, and recording during the scanning output signals Jxᵢ, i=1, . . . , 4 from the output ports 431-434 of the X-channel OM 420X and output signals Jyᵢ, i=1, . . . , 4 from the output ports 431-434 of the Y-channel OM 420Y, for example using the PDs 441 coupled to each of the output ports of the respective OMs. The phase error and the power balance of each of the OM 420X and 420Y may be estimated as generally described above with reference to FIGS. 4 and 5.

The OMs 420X and 420Y may be for example each embodied with an MMI coupler, for example a 4×4 MMI coupler in which one of the four input ports is not connected to either the test port or any of the input optical ports of the PIC. The OMs 420X and 420Y may each also be embodied as a compact 90° optical hybrid formed with a network of three 2×2 directional couplers and one phase-symmetrical optical splitter, as described in U.S. patent application Ser. No. 15/659,220, now U.S. Pat. No. 10,126,498, which is assigned to the assignee of the present application and is incorporated herein for reference. In this embodiment one of two input ports of one of the three 2×2 optical couplers remains unused when operating as a 90° optical hybrid, and may be coupled to a test port.

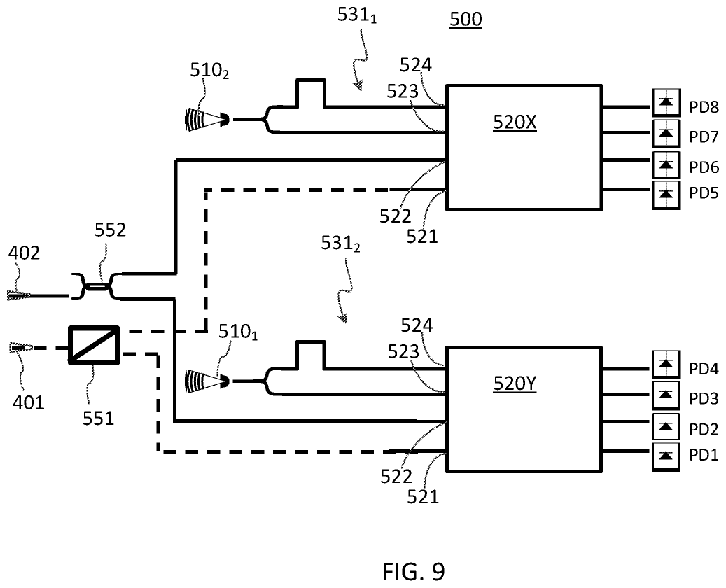

FIG. 9 schematically illustrates an example PIC 500 that is configured for coherent DP optical reception in accordance with an embodiment. Similarly to PIC 400, PIC 500 includes a polarization beam splitter/rotator (PBSR) 551 that is optically coupled to a first OM 520X for processing an X-channel polarization and a second OM 520Y for processing a Y-channel polarization. The first OM 520X and the second OM 520Y may be each embodied as a 90° optical hybrid having four output ports, two operative input ports 521 and 522, and two idle ports 523, 524. The output ports of each of the first OM 520X and the second OM 520Y is individually coupled to a corresponding PD. The PBSR 551 is optically coupled to a first PIC port 401. The first operative input ports 521 of the first and second OMs 520X, 520Y are coupled to different output ports of the PBSR 551. The second operative input ports 522 of the first and second OMs 520X, 520Y are coupled to different output ports of a beam splitter 552, which is disposed to receive LO light from a second PIC port 402. The idle ports 523, 524 of the first OM 520X are optically coupled to a first test port 510₁ by two optical waveguides forming a first unbalanced MZI 531₁, generally as described above with reference to FIG. 2. The idle ports 523, 524 of the second OM 520Y are optically coupled to a second test port 510₂ by two optical waveguides forming a second unbalanced MZI 531₂, also as described above with reference to FIG. 2. The first and second OMs 520X, 520Y may be separately tested, for example as described above with reference to FIGS. 2-5.

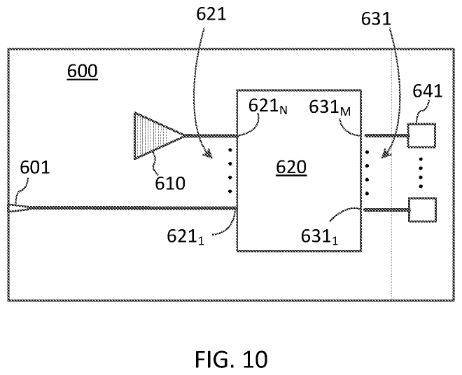

Referring to FIG. 10, there is illustrated an example PIC 600 including an OM 620 that is configured as a 1×M optical splitter, where M≥2. The optical mixer 620 may be in the form of an N×M optical coupler that has N input ports 621, including a first input port 621₁ and an N-th input port 621_{N}, where N≥2, and M output ports 631 including a first output port 631-1 and an M-th output port 621m. The first input port 621₁ of the OM 620 is an operative input port of the OM and is optically coupled to an input optical port 610, which may be an edge coupler. In operation, optical signals received into the input optical port 601 may be split M-ways by the OM 620, exiting from the M output ports 631 of the OM 620. The remaining (N−1) input ports 621 of the OM 620 remain idle during normal operation of the PIC, and may be used to assess splitting ratios r₁ₘ, of the OM 620, where r₁ₘ is a fraction of the input light that exits from m-th output port 631 of the OM 620. An input test port 610 in the form of a vertical coupler may be optically coupled to one of the idle input ports of the OM 620, for example an idle port 621_{N}. In some embodiments with N>2, an idle input port of OM 620 that has a symmetry property with an operating input port of the OM 620 may be connected to the test port 610 and used for testing; for example an idle input port that is symmetrically disposed from the operative input port may be used for testing when the OM 620 is embodied using an MMI coupler. Output test ports 641 may be individually coupled to the output ports 631 of the OM 620 to assist in the testing. In some embodiments the output ports 641 may each be in the form of a PD. In some embodiments the output ports 641 may each be in the form of a vertical coupler that re-directs light exiting a respective output port 631 of the OM 620 towards externally positioned PDs during measurements. In some embodiments the output ports 641 may be located on a sacrificial portion of the substrate that may be separated from the PIC after on-wafer testing. In some embodiments OM 620 may be for example a 2×2 directional coupler. In some embodiments OM 620 may be for example an N×N MMI coupler, where N>2, for example a 3×3 MMI coupler or 4×4 MMI coupler. By way of example, OM 620 may also be embodied as a compact 90° optical hybrid disclosed in U.S. Pat. No. 10,126,498 to Ma et al.

Advantageously, the use of vertical couplers as the test ports 108-110, 310, 410 as described hereinabove enables to perform PIC testing on-wafer, prior to wafer being diced into separate chips and packing the chips into target devices, which allows for automated testing of many chips at once, and potentially providing significant time and cost saving. The test ports 108-110, 310, 410, 610 may either remain on-chip after the dicing and packaging, or they may be cut off and discarded. In embodiments wherein the test port(s) remain with the chips, the testing of the PICs generally described above may also be performed on individual chips after separation from the rest of the wafer. In some embodiments the PIC testing using idle ports of the on-chip OM may be performed with the PIC input optical ports 101, 102, 301, 302, 401, 402, 601 connected to an optical system during an idle time of the system. In various embodiments, the PDs 141, 341, 441 may be integrally formed in the same chip or wafer as the corresponding OM being tested, or they can be fabricated separately from the rest of the PIC and otherwise integrated with the PIC.

According to example embodiments disclosed above with reference to FIGS. 1-10, provided is a photonic integrated circuit (PIC) (e.g. 100, 300, 400, 500, 600) comprising: one or more optical layers (e.g. 22) supported by a substrate (e.g. 15), one or more input optical ports (e.g. 101, 102, 301, 302, 401, 402, 601) for receiving light signals during normal operation of the PIC; a first optical mixer (e.g. 120, 320, 420X, 520X, 610) formed in the optical layer, the first optical mixer comprising: a plurality of output ports (e.g. 131-134, 331-333, 431-434, 631) and a plurality of input ports (e.g. 121-124, 331-333, 421-424, 521-524, 621), the plurality of input ports comprising one or more operative input ports (e.g. 121-122, 321-322, 421-422, 521-522, 621₁) optically coupled to the one or more input optical ports, and at least one idle input port (e.g. 133-134, 333, 433-434, 523-524, 621_{N}); a first test port (e.g. 108, 109, 110, 310, 410, 510₁, 510₂, 610) supported by the substrate and configured to couple test light into at least one of the one or more idle ports for optical testing of the first optical mixer. In some embodiments the first test port comprises a vertical coupler configured to receive test light (e.g. 151) incident thereon at an angle to the one or more optical layers and to redirect the test light to couple into the one or more idle ports so at to enable on-wafer optical testing of the optical mixer. In some embodiments the PIC may comprise a plurality of photodetectors (e.g. 141, 341, 441, 641, PD1-PD8) individually coupled to the two or more output ports of the first optical mixer.

In some embodiments the PIC may be configured for use in a coherent optical receiver. In some embodiments the first optical mixer (e.g. 120, 420, 520) may comprise a 90° optical hybrid. In some embodiments the first optical mixer may comprise one of: a 4×4 MMI coupler, a 3×3 MMI, or a network of waveguide couplers. In some embodiments the first optical mixer (e.g. 320) may be a 120° optical hybrid.

In some embodiments the PIC comprises a waveguide interconnect (e.g. 158, 318, 418, 531₁, 531₂) comprising a first optical splitter (e.g. 115, 315, 415) and configured to optically connect the first test port to two input ports (e.g. 123 and 124, 332 and 333, 422 and 423, or 523 and 524) of the first optical mixer, the two input ports comprising at least one idle port (123, 323, 423, 523, 621_{N}). In some embodiments the waveguide interconnect comprises a first optical path (e.g. 111, 311, 411) optically connecting the first test port to one of the two input ports (e.g. 123, 323, or 423), and a second optical path (e.g. 112, 312, or 412) optically connecting the first test port to the other of the two input ports (e.g. 124, 322, 422). In some embodiments the first optical path differs in length from the second optical path by at least 20 micrometers.

In some embodiments the at least one idle port comprises a first idle port (e.g. 123, 523) and a second idle port (e.g. 124, 524), and the first optical path optically connects the first test port to the first idle port, and the second optical path optically connects the first test port to the second idle port.

In some embodiments (e.g. FIGS. 7, 8) the first optical mixer comprises two operative input ports and one idle port, the first optical path optically connects the first test port to one of the two operative input ports, and the second optical path optically connects the first test port to the one idle port.

In some embodiments (e.g. FIG. 6) the PIC may comprise a second test port (e.g. 108) optically coupled to the first idle port of the first optical mixer and a third test port (e.g. 109) optically coupled to the second idle port of the first optical mixer for selectively injecting test light into the first optical mixer through one of the first idle port or the second idle port thereof.

In some embodiments (e.g. FIGS. 8 and 9) the PIC may be configured for dual-polarization coherent optical reception, and may further comprise a second optical mixer (e.g. 420Y, 520Y), the second optical mixer comprising a plurality of output ports and a plurality of input ports, the plurality of input ports comprising one or more operative input ports optically coupled to the one or more input optical ports, and one or more idle ports. The waveguide interconnect may be configured to optically connect the first test port to two input ports of the second optical mixer along optical paths (e.g. 413, 414) of differing lengths, wherein the two input ports of the second optical mixer comprise at least one of the one or more idle ports.

Example embodiments disclosed above with reference to FIGS. 1-8 provide further an optical wafer (e.g. 10) comprising a plurality of photonic integrated circuits, each of which comprising an instance of a PIC (e.g. 100, 100a, 300, 400, 500, or 600) including a test port (e.g. 108, 109, 110, 310, 410, 510₁, 510₂, or 610) coupled to an idle port (e.g. 123, 124, 323, 423, 523, 524, 621_{N}) of an optical mixer.

An aspect of the present disclosure provides a method for testing a photonic integrated circuit (PIC) (e.g. 100, 100a, 300, 400, 500, or 600) including a test port (e.g. 108, 109, 110, 310, 410, 510₁, 510₂, or 610) comprising an optical mixer defined at least in part in an optical layer of a wafer, the optical mixer comprising a plurality of input ports and a plurality of output ports, the plurality of input ports comprising one or more operative input ports and one or more idle ports. The method may comprise: providing a first test port in the wafer, the first test port configured to receive test light incident thereon at an angle to the optical layer and to redirect the test light to propagate in the optical layer; and, optically connecting the first test port to the one or more idle ports of the optical mixer with one or more optical waveguides defined in the PIC. In some embodiments of the method the step or process of optically connecting may comprise connecting the first test port to two input ports of the optical mixer along two optical paths that differ in length by at least 20 microns, wherein the two input ports comprise the one or more idle ports.

An aspect of the present disclosure provides a method for on-wafer testing of a photonic integrated circuit (PIC) (e.g. 100, 100a, 300, 400, 500, or 600) comprising an optical mixer defined at least in part in an optical layer of a wafer, the optical mixer comprising a plurality of input ports and a plurality of output ports, the plurality of input ports comprising two or more operative input ports and one or more idle input ports. The method may comprise: coupling test light into at least one of the one or more idle ports of the optical mixer; and, measuring light exiting the optical mixer from at least to two of the output ports. In some embodiments of the method the step of coupling may comprise: splitting the test light into two light portions, and directing the two light portions to couple into two input ports of the optical mixer along optical paths of different lengths. The step of measuring may comprise: varying a wavelength of the test light across a test wavelength range; and recording a relative power of the light exiting each output port from the plurality of output ports of the optical mixer in dependence on the wavelength to obtain an output spectrum for each of the plurality of output ports. Some embodiments of the method may comprise comparing the output spectrum for two or more of the output ports to determine a phase error of the optical mixer.

In some embodiments of the method the PIC may comprise a plurality of photodetectors (PDs) individually coupled to the plurality of output ports; the step of coupling may comprise directing the test light to couple into one idle port from the one or more idle input ports of the optical mixer; the step of measuring may comprise recoding a PD signal from each PD of the plurality of PDs to estimate at least one of: a receiver responsivity per output port of the optical mixer, or relative port-to-port coupling coefficients per output port of the optical mixer.

In some embodiments the method comprises optically connecting the first test port to one of the two input ports of the optical mixer with a first optical path, and optically connecting the first test port to the other of the two input ports of the optical mixer with a second optical path that differs in length from the first optical path by at least 20 micrometers (μm).

The above-described exemplary embodiments are intended to be illustrative in all respects, rather than restrictive, of the present invention. Furthermore, various features and elements described hereinabove with reference to a particular embodiment are not meant to be limited thereto, and may be implemented in other embodiments. Furthermore, various other embodiments and modifications to the present disclosure, in addition to those described herein, will be apparent to those of ordinary skill in the art from the foregoing description and accompanying drawings.

For example, it will be appreciated that different dielectric materials and semiconductor materials other than silicon, including but not limited to compound semiconductor materials of groups commonly referred to as A3B5 and A2B4, such as GaAs, InP, and their alloys and compounds, may be used to fabricate the optical circuits example embodiments of which are described hereinabove. Furthermore in some embodiments different components of the PICs described herein by way of example may be formed in different layers of a photonic wafer, and may comprise inter-layer optical coupling elements. Furthermore, in some embodiments one or more of the input optical ports may not be edge couplers; for example in some embodiments, such as those implemented with suitable compound semiconductor materials, a source of the LO light may be incorporated in the PIC. Furthermore, in some embodiments the PDs recording the test light may be separate from the PIC. In some embodiments the output ports of the OM under test may be optically coupled to out-couplers, such as for example vertical couplers such as grating couplers, which in some embodiments may be disposed in a sacrificial portion of the wafer. Furthermore, in some embodiments the test port or ports may be disposed in a sacrificial portion of the PIC, which may be separated from the optical chip prior to incorporating the chip into a functional system. Furthermore, in some embodiments measurements through idle OM ports described hereinabove may be performed after dicing of the wafer into separate chips.

It will be understood by one skilled in the art that various other changes in detail may be affected therein without departing from the spirit and scope of the invention as defined by the appended claims.

What is claimed is:

1. A photonic integrated circuit (PIC) comprising:
one or more optical layers supported by a substrate;
one or more input optical ports configured to receive light signals during normal operation of the PIC;
a first optical mixer formed in the one or more optical layers and comprising:
a plurality of output ports, and,
a plurality of input ports comprising one or more operative input ports optically coupled to the one or more input optical ports, and at least one idle port; and,
a first test port supported by the substrate and configured to couple test light into at least one of the one or more idle ports for optical testing of the first optical mixer.

2. The PIC of claim 1 wherein the first test port comprises a vertical coupler configured to receive the test light incident thereon at an angle to the one or more optical layers and to redirect the test light to couple into the one or more optical layers so as to enable on-wafer testing of the first optical mixer.

3. The PIC of claim 1 wherein the one or more input optical ports comprise one or more edge couplers.

4. The PIC of claim 2 further comprising a plurality of photodetectors (PDs), each PD coupled to a different output port from the plurality of output ports of the first optical mixer.

5. The PIC of claim 4 further comprising a waveguide interconnect comprising a first optical splitter and configured to optically connect the first test port to two input ports of the first optical mixer, the two input ports comprising the at least one idle port.

6. The PIC of claim 5 wherein the waveguide interconnect comprises a first optical path optically connecting the first test port to one of the two input ports, and a second optical path optically connecting the first test port to the other of the two input ports, and wherein the first optical path differs in length from the second optical path by at least 20 microns.

7. The PIC of claim 6 wherein the first optical mixer comprises a 90° optical hybrid.

8. The PIC of claim 7 wherein the at least one idle port comprises a first idle port and a second idle port, and wherein the first optical path optically connects the first test port to the first idle port, and the second optical path optically connects the first test port to the second idle port.

9. The PIC of claim 6 wherein the first optical mixer comprises two operative input ports and one idle port, and wherein the first optical path optically connects the first test port to one of the two operative input ports, and the second optical path optically connects the first test port to the one idle port.

10. The PIC of claim 1 wherein the first optical mixer comprises one of: a 4×4 MMI coupler, a 3×3 MMI coupler, or a network of waveguide couplers.

11. The PIC of claim 8 further comprising a second test port optically coupled to the first idle port of the first optical mixer and a third vertical coupler optically coupled to the second idle port of the first optical mixer for selectively injecting test light into the first optical mixer through one of the first idle port or the second idle port thereof.

12. The PIC of claim 6 configured for dual-polarization coherent optical reception, further comprising a second optical mixer, the second optical mixer comprising a plurality of output ports and a plurality of input ports comprising one or more operative input ports optically coupled to the one or more input optical ports, and one or more idle ports; and,
wherein the waveguide interconnect is configured to optically connect the first test port to two input ports of the second optical mixer along optical paths of differing lengths, wherein the two input ports of the second optical mixer comprise at least one of the one or more idle ports.

13. An optical wafer comprising a plurality of integrated optical circuits, each of which comprising an instance of the PIC of claim 1.

14. A method for testing a photonic integrated circuit (PIC) comprising an optical mixer defined at least in part in an optical layer of a wafer, the optical mixer comprising a plurality of input ports and a plurality of output ports, the plurality of input ports comprising one or more operative input ports and one or more idle ports, the method comprising:
providing a first test port in the wafer, the first test port configured to receive test light incident thereon at an angle to the optical layer and to redirect the test light to propagate in the optical layer; and,
optically connecting the first test port to the one or more idle ports of the optical mixer with one or more optical waveguides defined in the PIC.

15. The method of claim 14 wherein the optically connecting comprises connecting the first test port to two input ports of the optical mixer along two optical paths that differ in length by at least 20 microns, wherein the two input ports comprise the one or more idle ports.

16. A method for on-wafer testing of a photonic integrated circuit (PIC) comprising an optical mixer defined at least in part in an optical layer of a wafer, the optical mixer comprising a plurality of input ports and a plurality of output ports, the plurality of input ports comprising two or more operative input ports and one or more idle input ports, the method comprising:
coupling test light into at least one of the one or more idle ports of the optical mixer; and,
measuring light exiting the optical mixer from at least to two of the output ports.

17. The method of claim 16 wherein:
the coupling comprises:
splitting the test light into two light portions, and
directing the two light portions to couple into two input ports of the optical mixer along optical paths of different lengths;
the measuring comprises:
varying a wavelength of the test light across a test wavelength range, and
recoding a relative power of the light exiting each output port from the plurality of output ports of the optical mixer in dependence on the wavelength to obtain an output spectrum for each of the plurality of output ports.

18. The method of claim 17 further comprising comparing the output spectrum for two or more of the output ports to determine a phase error of the optical mixer.

19. The method of claim 17 wherein the optical mixer comprises a 90° optical hybrid.

20. The method of claim 16 wherein the PIC comprises a plurality of photodetectors (PDs) individually coupled to the plurality of output ports, and wherein:
the coupling comprises directing the test light to couple into one idle port from the one or more idle input ports of the optical mixer;
the measuring comprises recoding a PD signal from each PD of the plurality of PDs to estimate at least one of: a receiver responsivity per output port of the optical mixer, or relative port-to-port coupling coefficients per output port of the optical mixer.
